(19) United States
(12) Patent Application Publication
(10) Pub. No.: US 2021/0400173 A1
(43) Pub. Date: Dec. 23, 2021

(54) MULTI-ROBOTIC LIVE PRODUCTION AND WEBCAST VIDEOGRAPHIC SYSTEM

(71) Applicant: Li-Chieh Cheng, Taipei City (TW)

(72) Inventor: Li-Chieh Cheng, Taipei City (TW)

(21) Appl. No.: 16/908,752

(22) Filed: Jun. 23, 2020

(51) Int. Cl. H04N 5/222; G05B 13/02; G05D 1/00; G05D 1/02; H04N 5/232; H04N 5/77

(52) U.S. Cl. CPC H04N 5/2228; G05B 13/0265; G05D 1/0022; H04N 5/77; G05D 1/0287; H04N 5/23203; H04N 5/23245; G05D 1/0094

(57) ABSTRACT

A multi-robotic live production and webcast videographic system includes at least one videographic robot operating automatically and performing videography on spot through specific rules or by its own ability after learning; a main controller being a remote control device for receiving video or voice messages from at least one videographic robot; the receiving messages and production data of the main controller being stored in an videographic database; and at least one operation mode unit for determining operation modes of the videographic robot so that the videographic robot acts according to the operation mode; the operation mode unit including an operation mode database which stores various specific operation modes including a logic mode, an AI mode and a scenario mode so that the videographic robot may move to a desire position and adjust the shooting angle according to a selected operation mode.

### FIELD OF THE INVENTION

The present invention is related to videographic robots, and in particular to a multi-robotic live production and webcast videographic system.

### BACKGROUND OF THE INVENTION

Due to the fast development of image technology, videography is required in many fields, such as broadcasting or webcasting of ball games, major events, scenic areas, video shoots, concerts, lives, etc.

Conventionally, on-spot broadcasting for large world scale sports games, a TV station needs to send a large team of photojournalists and cameramen to the ball game site to report many different matches or rounds of games on spot. However, nowadays the labor costs become higher and higher. For a ball game, it is necessary to capture preferred images from a good view angle, but this often needs to capture the images of the objects from different view angles and then to select a perfect and preferred one, but it needs to have many journalists to do such works for getting a perfect and preferred one, but this will increase the overall costs of labor, and thus it becomes impossible. Furthermore, to arrange many different cameras in different view angles and arrange signal transmission cable paths for all these cameras also increase the overall cost. Moreover, these equipments and transmission cables form the obstacles to people walking. If the signal transmission is wireless, engineers must install transceivers between the camera equipments and signal processing devices on spot. It is time consumed. Furthermore some world-scale sports games have many matches and rounds, and thus these become the additional loadings to the engineers.

Due to development of artificial intelligence, many prior manual operation loadings can be replaced by related software and automatic machines so as to save labor and time costs. Therefore, the object of the present invention is to provide a novel design which can resolve the defects in the prior art by using AI technologies.

### SUMMARY OF THE INVENTION

Accordingly, to improve above mentioned defect in the prior art, the present invention provides a multi-robotic live production and webcast videographic system, wherein the videography paths or positions or coverage (scopes) can be planned automatically based on preset paths or learning abilities. The present invention provides different operation modes including a logic mode, an AI mode and a scenario mode so that the videographic robot may move to a desire position and adjust the videography angle. Further, the recording data is transferred to the main controller. The on-spot footage selection of the main controller also has various modes for switching, recording and storing of the broadcast video files footages. Therefore, the works of on-spot videography, video switching, processing and recording can be performed automatically without manual operations. Therefore, the present invention can be widely used in many different fields, such as broadcasting of ball games, major events, scenic area reports, video shoots, etc. without any on-spot human-power so that costs of labors, arrangement of equipments and lines are reduced greatly. Furthermore the videographic robots and main controller are arranged with different operation modes. The focuses and videography coverage for videography are adjustable. It is very flexible in use and the required footages can be acquired.

To achieve above goal, the present invention provides a multi-robotic live production and webcast videographic system, comprising: at least one videographic robot operated automatically without manual operations, but performing videography on spot through specific rules or by its own ability after learning; the videography operations of the videographic robot includes capturing of images and sounds; the videographic robot moving by itself without manual operations; a main controller being a remote control device, installed far end or near end by wired or wireless connections with the videographic robot; or the main controller being directly installed in the videographic robot; the main controller serving for receiving video or voice messages from at least one videographic robot; the recording videos and live production works being controlled by an on-spot video director; the receiving video signals and production data of the main controller being stored in a videographic database which being installed in an interior or an exterior of the videographic robots; at least one operation mode unit for determining operation modes of the videographic robot so that the videographic robot acts according to the operation mode; the operation mode unit including an operation mode database which stores various specific operation modes; wherein the operation mode unit is stored in the main controller of the videographic robot; the main controller calculates moving paths and positions and videography area of the at least one videographic robot; the videographic robot transmits capturing data or recoding data to the main controller; the videographic robot calculates the moving paths and stagnation positions for shootings and capturing directions of the videographic robot; the videographic robot transmits the capturing data or recording data to the main controller; the main controller selects desired footages from those data and makes them as a video by using a selected operation mode and then they are stored in the videographic database; when there are multiple videographic robots, there are also multiple operation mode units; and each operation mode unit is stored in respective videographic robots; a selected operation mode in the operation mode unit of each videographic robot calculates the moving paths and stagnation positions for shootings and capturing directions of each videographic robot real-time; the recoding data is transferred to the main controller; the on-spot footages transmissions are switched and live-produced based on a preset operation mode; and then the video is stored in the videographic database.

### BRIEF DESCRIPTION OF THE DRAWINGS

FIG. 1 is a schematic view showing an application of the present invention.

FIG. 2 is a block diagram showing the elements of the present invention.

FIG. 3 is another block diagram showing the elements of the present invention.

FIG. 4 is a further block diagram showing the elements of the present invention.

FIG. 5 is a block diagram showing the elements of the present invention.

FIG. 6 is a schematic view showing the operation modes of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

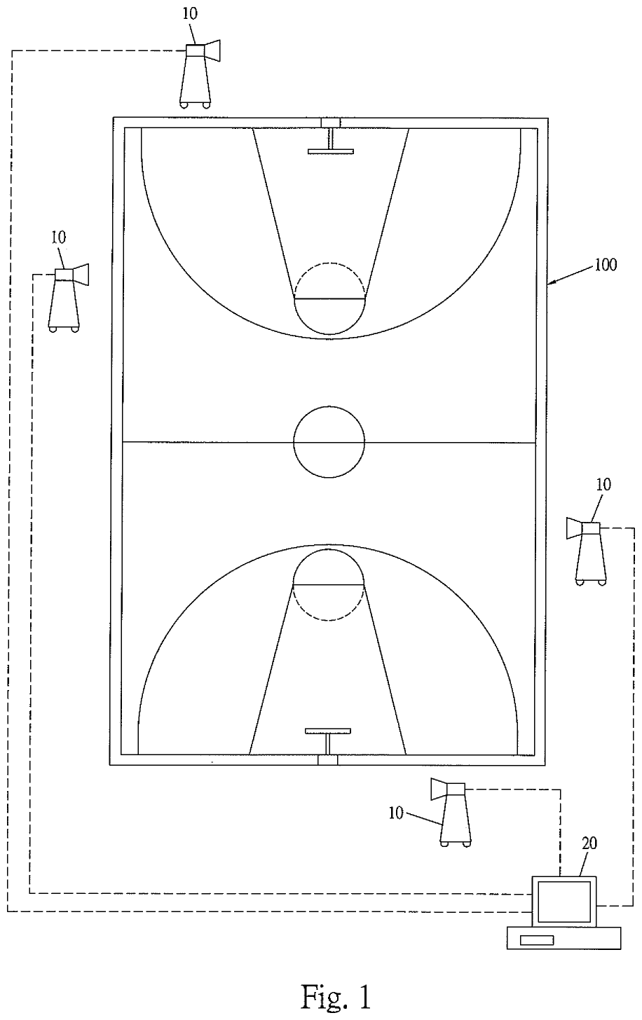

With reference to FIGS. 1 to 6, the multi-robotic live production and webcast videographic system of the present invention is illustrated. The present invention includes the following elements.

At least one videographic robot 10 is operated automatically without manual operations, but recording videos on spot through specific rules or by its own ability after learning. The videographic robot 10 is a robot installed with at least one camera or is a moving device installed with at least one camera. The videography of the videographic robot 10 includes capturing of images and sounds. The videographic robot 10 moves by itself without manual operations, for example, moving by moving mechanics of itself or moving along predetermined tracks. Furthermore, the videographic robot 10 may be, for example, an unmanned aerial vehicle (UAV) or an unmanned surface vehicle (USV).

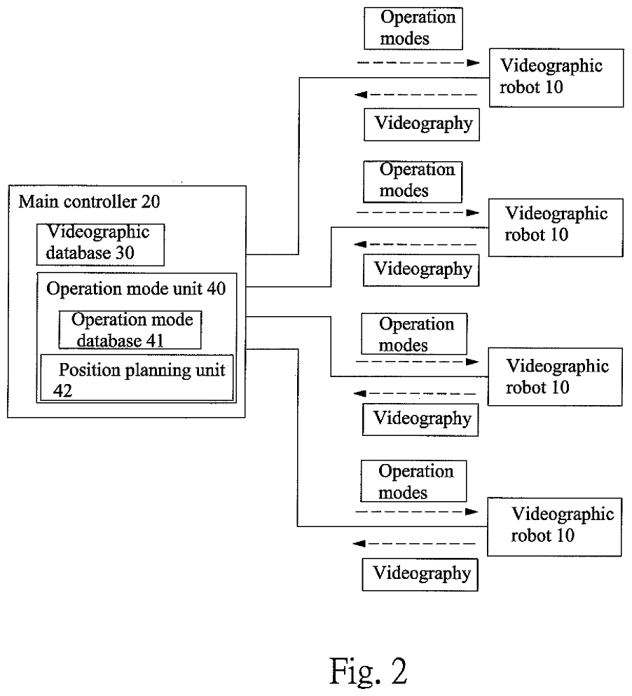

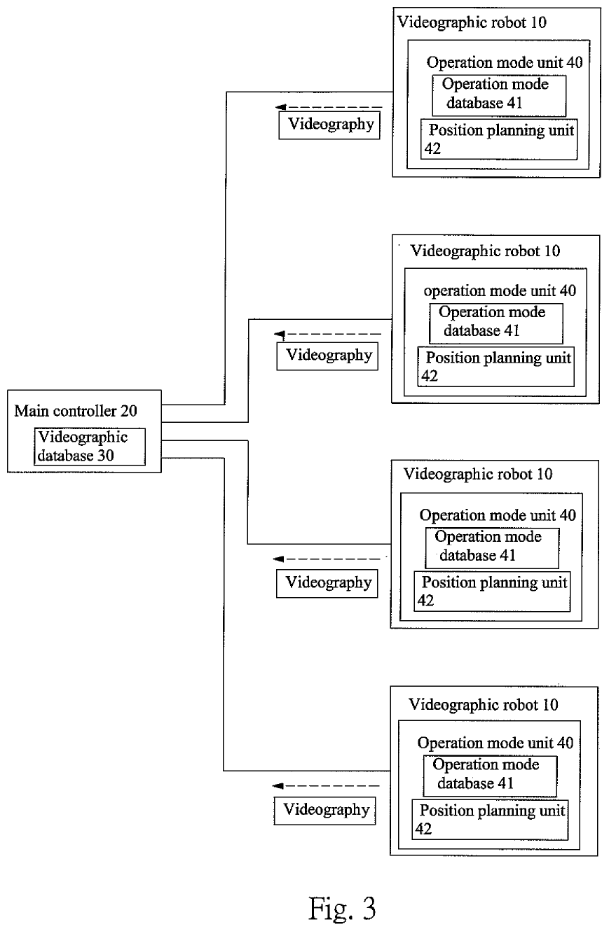

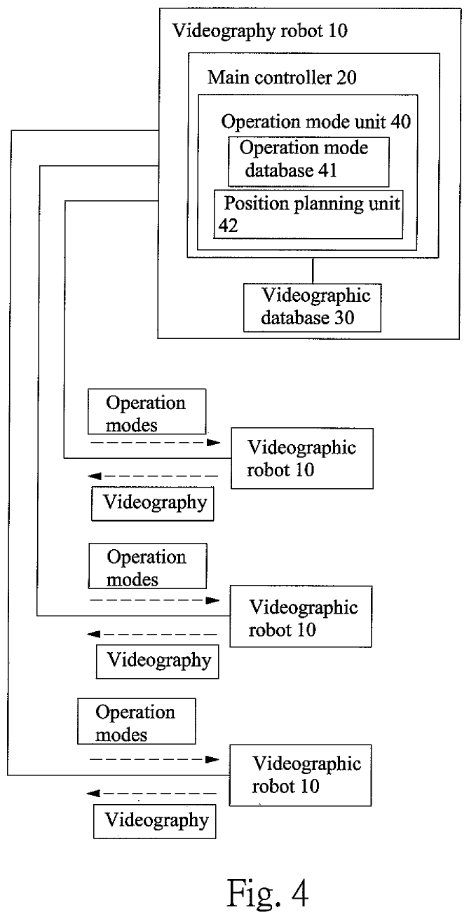

A main controller 20 is a remote controlled device, installed far end or near end by wired or wireless connections with the videographic robot 10 (referring to FIGS. 2 and 3). Furthermore, the main controller 20 can be directly installed in the videographic robot 10 (referring to FIG. 4).

With reference to FIG. 4, in the present invention, the at least one videographic robot 10 are multiple videographic robots 10. The main controller 20 is installed at one of multiple videographic robots 10. The main controller 20 serves to control these multiple videographic robots 10.

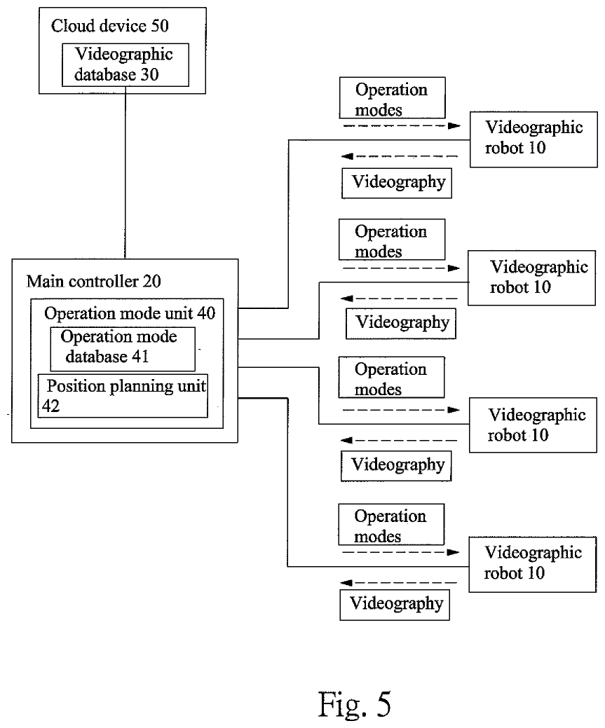

The main controller 20 serves to receive video or voice messages from at least one videographic robot 10. Furthermore, the recording footages and succeeding processing works are controlled by an on-spot videographic director. The receiving video signals and production data of the main controller 20 are stored in a videographic database 30 which is installed in one of the videographic robots 10, the main controller 20 and a cloud device 50 (referring to FIG. 5)

The main controller 20 serves to instruct the at least one videographic robot 10 to act. The main controller 20 has an enforce interruption function so that the main controller 20 can interrupt the actions of any one of the at least one videographic robot 10. Then a remote operator can instruct the at least one videographic robot 10 to act.

The present invention further includes at least one operation mode unit 40 for determining operation modes of the videographic robot 10 so that the videographic robot 10 acts according to the operation mode. The operation mode unit 40 includes an operation mode database 40 which stores various specific operation modes 410.

With reference to FIGS. 2 and 4, the operation mode unit 40 may be stored in the main controller 20. The main controller 20 calculates moving paths and stagnation positions for shootings and capturing directions of the at least one videographic robot 10. The videographic robot 10 transfers recoding data to the main controller 20. The videographic robot 10 calculates the moving paths and positions and videography areas of the videographic robot 10. The videographic robot 10 transfers the recording data to the main controller 20. The main controller 20 selects desired footages from the recording data and makes them as a movie or a video by using a preset operation mode and then they are stored in the videographic database 30. Or as illustrated in FIG. 3, the at least one operation mode unit 40 is a plurality of operation mode units 40. Each operation mode unit 40 is stored in a respective videographic robot 10. A selected operation mode in the operation mode unit 40 of a specific videographic robot 10 calculates the moving paths and positions and the capturing directions of the videographic robot 10 real-time. The recoding data is transferred to the main controller 20. The on-spot footage transmissions are switched and edited based on the preset operation mode. Then the video or movie is stored on the videographic database 30.

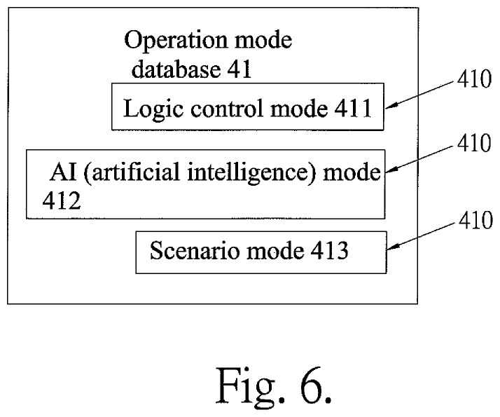

As illustrated in FIG. 6, in the present invention, the operation mode has the following different types.

A first type of the operation mode unit 40 is a logic control mode 411 which guides videography footages by preset logics. One of the preset logics divides the focuses for capturing images as primary focuses, secondary focuses, third focuses, etc. as priority of videography.

In this mode, the operator can set the priorities of videography focuses. For the focuses of higher priority, videography based on these focuses can be performed for longer time. For example, in a basketball game, if the footages exists the images of a super star sports player, the videographic robot 10 takes more time to capture footages about this super star sports player.

For example, when playing a ball game, four focuses may be set. The first one is the ball, the second is members near the ball, such as players or coaches, the third is players or coaches far away from the ball, and the fourth is audiences. When there are four videographic robots 10, each videographic robot 10 is assigned with a specific focus. If the number of the videographic robots 10 is not four, then a preset logic may distribute the videographic robots 10 with different focuses. For example, if there is only one photograph robot 10, the videographic robot 10 will focus on all of above mentioned four focuses in turn or the footages for videography are adjusted to be in near field or far field in turn. FIG. 1 shows that four videographic robots 10 are arranged on four different positions of a basketball court.

For example, for webcasting of a scenic area, the footage capturing may be static or dynamic. For example, a dynamic object is indicated as a first focus, and a static object is indicated as a second object. A complete static scenic area has be set with some dynamic focuses, some static focuses.

The videographic robot 10 is installed with functions of tracing and identification for tracing and identifying the objects in the capturing images and thus auto video recording can be performed.

A second operation mode is an AI (artificial intelligence) mode 412. In that, a videographic robot 10 is installed in a robot with learning ability. The learnable robot initially learns or trains about specific object in advance. The results from the learning or training are stored in the videographic robot 10 so that the videographic robot 10 may perform auto recording actions for the specific object. For example, the learning robot views broadcastings of ball games many times for learning the key points (focus points) in the broadcasting. Then the learning robot performs recording operations for on-spot ball games many times for enhancing the abilities of the learning robot.

In this mode, the operator may set priorities of videography by force so that in broadcasting, the images with higher priorities can be traced and captured with higher frequencies.

The third operation mode is a scenario mode 413 which is aimed to plan the actions of the videographic robot 10 with preset procedures. This mode is especially used in recording of the video of such as an opera, a duologue or a concert, etc. The scenario mode 413 instructs the videographic robot 10 to capture images according to the contents of the opera, the duologue or the concert, etc.

In the present invention, the main controller 20 is capable of being switched to be operated manually, that is, the main controller 20 is controlled by the operator. The video switching and combination are controlled directly by the operator, or the operator instructs the videographic robot 10 to capture images according to the setting of the main controller 20.

Based on above description, the main controller 20 can be operated by the any one of the above mentioned operation modes or the operation modes of the main controller 20 are switched between above mentioned operation modes

The operation mode unit 40 further includes a position planning unit 42 for planning on-spot moving paths or positions and videography coverage of the videographic robot 10. For example, when there are multiple videographic robots 10, the position planning unit 42 assigns different on-spot areas to these videographic robots 10. For example, in a basketball game, if there are only two videographic robots 10, each videographic robot 10 is assigned with a half of the court so that the videographic robots 10 may have preferred views for videography and moving paths are shorter, or each videographic robot 10 is planed with a moving path.

Advantages of the present invention are that the videography paths or positions or coverage (scopes) can be planned automatically based on preset paths or learning abilities. The present invention provides different operation modes including a logic mode, an AI mode and a scenario mode so that the videographic robot may move to a desire position and adjust the shooting angle. Further, the recording data is transferred to the main controller. The on-spot footage selection of the main controller also has various modes for switching, recording and storing of the broadcast footages. Therefore, the works of on-spot videography, video switching, processing and recording can be performed automatically without manual operations. Therefore, the present invention can be widely used in many different fields, such as broadcasting of ball games, major events, scenic area reports, video shoots, etc. without any on-spot people so that costs of labors, arrangement of equipments and lines are reduced greatly. Furthermore the videographic robots and main controller are arranged with different operation modes. The focuses and videography coverage for videography are adjustable. It is very flexible in use and the required footages can be acquired.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-robotic live production and webcast videographic system, comprising:
at least one videographic robot operating automatically without manual operations, but performing videography on spot through specific rules or by its own ability after learning; the videographic operations of the videographic robot includes capturing of imaged and sounds; the videographic robot moving by itself without manual operations;
a main controller being a remote control device, installed far end or near end by wired or wireless connections with the videographic robot; or the main controller being directly installed in the videographic robot;
the main controller serving for receiving video or voice messages from at least one videographic robot; the recording footages and live production works being controlled by an on-spot director; the receiving video signals and production data of the main controller being stored in a videographic database which being installed in an interior or an exterior of the videographic robots;
at least one operation mode unit for determining operation modes of the videographic robot so that the videographic robot acts according to the operation mode; the operation mode unit including an operation mode database which stores various specific operation modes; and
wherein the operation mode unit is stored in the main controller of in the videographic robot; the main controller calculates moving paths and positions and videography area of the at least one videographic robot; the videographic robot transfers recoding data to the main controller; the videographic robot calculates the moving paths and positions and videography areas of the videographic robot; the videographic robot transmits the recording data to the main controller; the main controller selects desired footages from the recording data and makes them as a movie or a video by using a selected operation mode and then they are stored in the videographic database; when there are multiple videographic robots, there are also multiple operation mode units; and each operation mode unit is stored in respective videographic robots; a selected operation mode in the operation mode unit of each videographic robot calculates the moving paths and positions and the shooting directions of each videographic robot realtime; the recoding data is transferred to the main controller; the on-spot transferring fames are switched and live-produced as a video or movie based on a preset operation mode; and then the video or movie is stored on the videographic database.

2. The multi-robotic live production and webcast videographic system as claimed in claim 1, wherein the operation mode unit is a logic control mode which guides videography of the videographic robot by preset logics.

3. The multi-robotic live production and webcast videographic system as claimed in claim 2, wherein the logic control mode divides image capturing areas of videography into a plurality of focuses for determining time period for videography.

4. The multi-robotic live production and webcast videographic system as claimed in claim 3, wherein an operator sets priorities of the videography focus; for a videography with a focus of higher priority, the videography is performed for longer time.

5. The multi-robotic live production and webcast videographic system as claimed in claim 1, wherein the operation mode is an AI (artificial intelligence) mode; in that, a videographic robot is installed in a robot with learning ability; the learnable robot initially learns or trains about a specific object in advance; the results from the learning or training are stored in the videographic robot so that the videographic robot performs actions of auto videography for the specific object.

6. The multi-robotic live production and webcast videographic system as claimed in claim 5, wherein the operator is able to set priorities of the shooting focus by force so that in broadcasting, the shooting focus with higher priorities are traced and videography with higher frequencies.

7. The multi-robotic live production and webcast videographic system as claimed in claim 1, wherein the videographic robot has functions of tracing and identification so that in broadcasting, the videographic robot can trace and identify a specific object.

8. The multi-robotic live production and webcast videographic system as claimed in claim 1, wherein the operation mode is a scenario mode which is aimed to plan actions of the videographic robot with preset procedures; the scenario mode instructs the videographic robot to videography according to contents of videography object.

9. The multi-robotic live production and webcast videographic system as claimed in claim 1, wherein the operation mode unit includes a position planning unit for planning on-spot moving paths or positions and videography coverages of the videographic robot; when there are a plurality of videographic robots, the position planning unit assigns different on-spot coverage to these videographic robots so that the videographic robot can capture preferred views for less moving paths in capturing, or each videographic robot is planed with their moving path.

10. The multi-robotic live production and webcast videographic system as claimed in claim 1, wherein the main controller instructs the at least one videographic robot to act; the main controller has an enforce interruption function so that the main controller can interrupt the actions of any one of the at least one videographic robot; then a remote operator can instruct the at least one videographic robot to act.

11. The multi-robotic live production and webcast videographic system as claimed in claim 1, wherein the at least one videographic robots are multiple videographic robots and the main controller is installed in one of these multiple videographic robots.

12. The multi-robotic live production and webcast videographic system as claimed in claim 1, wherein the videographic robot moves by moving mechanics of itself or moving along predetermined tracks.

13. The multi-robotic live production and webcast videographic system as claimed in claim 1, wherein the videographic database is installed in one of the at least one videographic robot, the main controller and a cloud device.

14. The multi-robotic live production and webcast videographic system as claimed in claim 1, wherein the videographic robot is selected from one of an unmanned aerial vehicle and an unmanned surface vehicle.

15. The multi-robotic live production and webcast videographic system as claimed in claim 1, wherein the main controller is capable of being switched to manual operation, that is, the main controller is controlled by the operator; the frame switching and combination are controlled directly by the operator, or the operator instructs the videographic robot according to settings of the main controller.

16. The multi-robotic live production and webcast videographic system as claimed in claim 1, wherein the main controller is operated based on one of the operation mode of the operation mode unit; and video combination is based on the operation mode.

17. The multi-robotic live production and webcast videographic system as claimed in claim 1, wherein the videographic robot is a robot installed with at least one camera or is a movable device installed with at least one camera.
